(19) United States
(12) Patent Application Publication
(10) Pub. No.: US 2023/0134448 A1
(43) Pub. Date: May 4, 2023

(54) THERMOPLASTIC POLYURETHANE HAVING HIGH FLEXURAL STRESS

(71) Applicant: Covestro Intellectual Property GmbH & Co. KG, Leverkusen (DE)

(72) Inventors: Mathias MATNER, Neuss (DE); Thomas KOENIG, Leverkusen (DE); Bernd GARSKA, Köln (DE); Rainer BELLINGHAUSEN, Odenthal (DE); Thomas PRENVEILLE, Ecardenville-La-Campagne (FR); Claudia HOUBEN, Heinsberg (DE)

(21) Appl. No.: 17/780,643

(22) PCT Filed: Dec. 10, 2020
(86) PCT No.: PCT/EP2020/085499

§ 371 Date: May 27, 2022

(30) Foreign Application Priority Data
Dec. 17, 2019 (EP) 19216820.1

(51) Int. Cl. C08G 18/73; C08L 75/04; C08G 18/32; C08G 18/10; C08G 18/08

(52) U.S. Cl. CPC C08G 18/73; C08L 75/04; C08G 18/3206; C08G 18/10; C08G 18/0895

(57) ABSTRACT

The invention relates to a thermoplastic polyurethane obtainable by the reaction of at least the following formation components: one or more aliphatic diisocyanates A) having a molecular weight of 140 g/mol to 170 g/mol and one or more aliphatic diols B) having a molecular weight of 62 g/mol to 120 g/mol, wherein the formation components used to produce the thermoplastic polyurethane consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, and to a process for preparation thereof, and to compositions, mouldings, films and/or fibres comprising the thermoplastic polyurethane.

The invention relates to a thermoplastic polyurethane obtainable by the reaction of at least the following formation components: one or more aliphatic diisocyanates A) having a molecular weight of 140 g/mol to 170 g/mol and one or more aliphatic diols B) having a molecular weight of 62 g/mol to 120 g/mol, wherein the formation components used to produce the thermoplastic polyurethane consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, and to a process for preparation thereof, and to compositions, mouldings, films and/or fibres comprising the thermoplastic polyurethane.

Owing to their excellent physical properties, polyurethanes and especially thermoplastic polyurethanes have been used for a wide variety of different end uses for many years. In spite of the broad usability of polyurethanes, there are fields of application in which other plastics, for example polyamide plastics, are used because there are no polyurethanes having suitable physical properties available or these can be provided only with difficulty.

Polyurethanes formed from short-chain aliphatic diols and short-chain aliphatic polyisocyanates have properties comparable to or better than the polyamide plastics, for example with regard to the paintability of the plastic. However, the various possible reactions of the isocyanates are found to be disadvantageous in respect of the production of thermoplastic polyurethanes. By virtue of the polyaddition reaction between isocyanate and hydroxyl groups, molecular weights that suggest good mechanical properties are attained only at very high conversions. At high conversions, however, there is also a rise in the tendency to side reactions, for example the formation of allophanate, biuret or isocyanurate groups, which constitute branch points in the polymer structure and hence reduce the thermoplastic character or even, in the extreme case, result in thermosets (G. Oertel, Kunststoff-Handbuch [Plastics Handbook], vol. 7, 3rd ed., 1993, p. 12ff). Moreover, the mechanical properties are dependent on the preparation process.

O. Bayer (Angew. Chem. 1947, 59, 257-288) discloses the preparation of polyurethanes from aliphatic diisocyanates and aliphatic diols in a batchwise process, especially a polyurethane formed from hexamethylene 1,6-diisocyanate and butane-1,4-diol (Perlon U, Igamid U), which is obtained as a fine, sandy powder from a precipitation polymerization in dichlorobenzene.

DE728981 discloses the preparation of polyurethanes and polyureas in a solvent-containing or solvent-free batchwise process.

V. V. Korshak (Soviet Plastics 1961, 7, 12-15) discloses a semibatchwise laboratory process for preparation of a polyurethane from hexamethylene 1,6-diisocyanate and butane-1,4-diol. For this purpose, hexamethylene 1,6-diisocyanate is introduced dropwise into heated butane-1,4-diol, which leads to a brittle addition product.

According to the process employed, the polyurethanes produced according to the prior art have different properties. Especially polyurethanes that are prepared by these processes and are formed from short-chain aliphatic diols and short-chain aliphatic polyisocyanates have a low flexural stress, which limits their use in some applications. An additional factor is that the known batchwise and semibatchwise processes are difficult to scale up, which distinctly restricts access to the industrial scale or even makes it impossible.

Therefore, various measures are being taken to minimize side reactions and to conduct the reaction as close as possible to the ideal polyaddition described by Schulz and Flory, and to achieve a minimum polydispersity.

It was therefore an object of the present invention to provide a thermoplastic polyurethane with a high flexural stress.

It was a further object of the invention to provide a process for preparing the thermoplastic polyurethanes according to the invention on the basis of aliphatic components, said process enabling thermally controllable and cost-efficient operation.

It was a further object of the invention to provide mouldings, films or fibres made from the thermoplastic polyurethane.

At least one of these objects is achieved by a thermoplastic polyurethane obtainable by the reaction of at least the following formation components:

A) one or more aliphatic diisocyanates having a molecular weight of 140 g/mol to 170 g/mol and

B) one or more aliphatic diols having a molecular weight of 62 g/mol to 120 g/mol,

wherein the formation components used to produce the thermoplastic polyurethane consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

It has now been found that, surprisingly, the thermoplastic polyurethanes according to the invention have very good mechanical properties, especially a high flexural stress, whereas known polyurethanes that are likewise formed from short-chain aliphatic diols and short-chain aliphatic polyisocyanates are very brittle and hence barely suitable for industrial applications in which a sufficiently high flexural stress is required. The thermoplastic polyurethanes according to the invention may contain minor thermoset components in the polymer matrix, as result, for example, from allophanate structural elements, biuret structural elements or from the proportional use of triols or triisocyanates as monomers, but only such a degree that the thermoplastic properties of the polyurethanes according to the invention are maintained. Typically, there is 0.5% by weight-5% by weight, preferably 0.5% by weight-4% by weight, more preferably 0.5% by weight-3% by weight, even more preferably 0.5% by weight-2% by weight and most preferably 0.5% by weight-1% by weight of thermoset components, based on the total weight of the thermoplastic polymer according to the invention.

Unless explicitly stated otherwise, all percentages are based on weight (% by weight). The unit “% by weight” is based here on the total weight of the respective system or the total weight of the respective component. For example, a copolymer may have a content of a particular monomer that is expressed in % by weight, in which case the percentages by weight would be based on the total weight of the copolymer.

The word “a” in the context of the present invention in association with countable parameters should be understood to mean the number “one” only when this is stated explicitly (for instance by the expression “exactly one”). When reference is made hereinafter to “a polyol”, for example, the word “a” should be regarded merely as the indefinite article and not the number “one”, meaning that an embodiment comprising a mixture of at least two polyols is also encompassed.

“Aliphatic” or “aliphatic radical” are understood in the context of the invention to mean acyclic saturated hydrocarbyl radicals that are branched or linear and preferably unsubstituted. These aliphatic hydrocarbyl radicals preferably contain 2, 3, 4, 5 or 6 carbon atoms. The aliphatic polyurethane according to the invention has been formed from polyols and polyisocyanates each having acyclic saturated hydrocarbon skeletons, for example 1,6-diisocyanatohexane (HDI) and butane-1,4-diol (BDO).

The thermoplastic aliphatic polyurethane according to the invention preferably consists essentially of unbranched linear polymer chains, more preferably essentially of unbranched linear unsubstituted polymer chains, where the polymer chains do not contain any cycloaliphatic groups. What is meant by “essentially” in this connection is that at least 95 mol %, preferably at least 98 mol %, more preferably at least 99 mol % and even more preferably at least 99.5 mol % of the polymer chains of the thermoplastic aliphatic polyurethane consists of unbranched linear polymer chains, preferably unbranched linear unsubstituted polymer chains, where the polymer chains do not contain any cycloaliphatic groups.

According to the invention, the terms “comprising” or “containing” preferably mean “consisting essentially of” and more preferably mean “consisting of”.

Unless explicitly stated otherwise, in the present invention, the centrifuge-average molar mass M̅_{z} is determined by means of gel permeation chromatography (GPC) using polymethylmethacrylate as standard. The sample to be analysed is dissolved in a solution of 3 g of potassium trifluoroacetate in 400 cubic centimetres of hexafluoroisopropanol (sample concentration about 2 mg/cubic centimetre), then applied via a pre-column at a flow rate of 1 cubic centimetre/minute and then separated by means of three series-connected chromatography columns, first by means of a 1000 Å PSS PFG 7 μm chromatography column, then by means of a 300 Å PSS PFG 7 μm chromatography column and lastly by means of a 100 Å PSS PFG 7 μm chromatography column. The detector used was a refractive index detector (RI detector). The centrifuge-average molar mass (M̅_{z}) was calculated from the data obtained by the gel permeation chromatography measurement with the aid of the following equation:

$${\overline{M}}_{z} = \frac{{\sum }_{i} {n}_{i} {M}_{i}^{3}}{{\sum }_{i} {n}_{i} {M}_{i}^{2}} in g / mol$$

where

Mᵢ is the molar mass of the polymers of the fraction i, such that Mᵢ<Mᵢ₊₁ for all i, in g/mol,

nᵢ is the molar amount of the polymer of the fraction i, in mol.

M̅ₚₑₐₖ is the molar mass of the maximum of the gel permeation chromatography curve. In order to determine M̅ₚₑₐₖ, the molar mass fractions determined by gel permeation chromatography are plotted logarithmically against the molar mass, with the molar mass fractions to scale with the molar mass in order to assure area equality of the plot.

The peak molar mass, M̅ₚₑₐₖ, is found from the maximum of this logarithmic plot to be

M̅ₚₑₐₖ=Mₖ, such that wₖ Mₖ=max(wᵢ Mᵢ) for all i, in g/mol,

where

Mₖ is the molar mass of the polymers of the fraction k in g/mol,

k is an index,

$${w}_{i} = \frac{{m}_{i}}{{m}_{g}}$$

is the proportion by mass of the polymer in the fraction i,

mᵢ is the mass of the polymer of the fraction i, mᵢ=nᵢMᵢ in g,

m_{g} is the total mass of the polymer, m_{g}=Σᵢmᵢ in g, and

Mᵢ is defined as above.

In other words: M̅ₚₑₐₖ is the molar mass at which the molar mass distribution curve reaches its maximum.

Unless explicitly stated otherwise, in the present invention, melting points and glass transition points are determined by means of DSC (differential scanning calorimetry) with a Mettler DSC 12E (Mettler Toledo GmbH, Giessen, DE) in accordance with DIN EN 61006 (November 2004). Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 20 K/min. Cooling was effected by means of liquid nitrogen. The purge gas used was nitrogen. The values reported are each based on the evaluation of the 2nd heating curve.

A preferred embodiment relates to a thermoplastic polyurethane polymer obtained or obtainable by the reaction of one or more aliphatic diisocyanates having a molecular weight of 140 g/mol to 170 g/mol and one or more aliphatic diols having a molecular weight of 62 g/mol to 120 g/mol and at least one chain extender, wherein, in a first step, at least one or more than one aliphatic diisocyanate A) having a molecular weight of 140 g/mol to 170 g/mol is reacted with one or more aliphatic diols B) having a molecular weight of 62 g/mol to 120 g/mol to give at least one prepolymer, preferably to give at least one hydroxy-terminated prepolymer, and the at least one prepolymer obtained in the first step is reacted in a second step with at least one chain extender to give the thermoplastic polyurethane polymer, wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a preferred embodiment, the reaction is effected in a loop reactor.

A preferred embodiment relates to a thermoplastic aliphatic polyurethane polymer obtained or obtainable by the reaction of one or more aliphatic diisocyanates A) having a molecular weight of 140 g/mol to 170 g/mol and one or more aliphatic diols B) having a molecular weight of 62 g/mol to 120 g/mol, optionally in the presence of at least one catalyst and/or auxiliaries and additives, wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic polyisocyanates and the one or more aliphatic polyols are used in a molar ratio in the range from 1.0:0.95 to 0.95:1.0, in a process comprising the following steps:
a) mixing a diisocyanate stream (A) and a diol stream (B) in a first mixing device (7), so as to obtain a mixed stream (C),
b) introducing the mixed stream (C) into a circulation stream (D) which is circulated, wherein the monomers of the diisocyanate stream (A) and of the diol stream (B) react further in the circulation stream (D) to give OH-functional prepolymers,
c) diverting a substream of circulation stream (D) as prepolymer stream (E) and introducing it into an extruder (18),
d) introducing an isocyanate feed stream (F) into the extruder (18) downstream of the introduction of the prepolymer stream (E) in the working direction of the extruder,
e) reacting the prepolymer stream (E) with the isocyanate feed stream (F) in the extruder (18) to obtain the thermoplastic polyurethane (G) as extrudate,
   characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a preferred embodiment, the M̅_{z}/M̅ₚₑₐₖ ratio of the thermoplastic polyurethane according to the invention is within a range from 3 to 14, preferably within a range from 3.5 to 14, more preferably within a range from 3.5 to 13, even more preferably within a range from 3.5 to 12.5, even more preferably still within a range from 3.5 to 12.

In a further preferred embodiment, the M̅_{z} of the thermoplastic polyurethane according to the invention is within a range from 100 000 g/mol to 900 000 g/mol, preferably within a range from 110 000 g/mol to 850 000 g/mol, more preferably within a range from 120 000 g/mol to 800 000 g/mol, even more preferably within a range from 125 000 g/mol to 770 000 g/mol, where M̅_{z} is the centrifuge-average molar mass, determined by gel permeation chromatography in hexafluoroisopropanol against polymethylmethacrylate as standard.

In a preferred embodiment, the thermoplastic polyurethane polymer according to the invention consists to an extent of at least 96% by weight, preferably to an extent of at least 97% by weight, more preferably to an extent of at least 98% by weight, even more preferably to an extent of at least 99% by weight, even more preferably still to an extent of at least 99.5% by weight and most preferably to an extent of at least 99.9% by weight of one or more aliphatic diisocyanates A) and one or more aliphatic diols B), based on the total mass of the polyurethane polymer.

Suitable aliphatic diisocyanates A) are all monomeric aliphatic diisocyanates known to the person skilled in the art that have a molecular weight of 140 g/mol to 170 g/mol. It is immaterial here whether the diisocyanates have been obtained by means of phosgenation or by a phosgene-free process. The diisocyanates and/or the precursor compounds of these may have been obtained from fossil or biological sources. Preference is given to preparing 1,6-diisocyanatohexane (HDI) from hexamethylene-1,6-diamine and 1,5-diisocyanatopentane from pentamethylene-1,5-diamine, with hexamethylene-1,6-diamine and pentamethylene-1,5-diamine having been obtained from biological sources, preferably by bacterial fermentation. The aliphatic diisocyanates for formation of the thermoplastic polyurethane polymer according to the invention are preferably selected from the group consisting of 1,4-diisocyanatobutane (BDI), 1,5-diisocyanatopentane (PDI), 1,6-diisocyanatohexane (HDI) and 2-methyl-1,5-diisocyanatopentane or a mixture of at least two of these.

In a preferred embodiment, the one or more aliphatic diisocyanates A) are selected from the group consisting of 1,4-diisocyanatobutane, 1,5-diisocyanatopentane, 1,6-diisocyanatohexane, 2-methyl-1,5-diisocyanatopentane and/or mixtures of at least two of these. In another preferred embodiment, 1,5-diisocyanatopentane and/or 1,6-diisocyanatohexane are used as aliphatic diisocyanates A). In a further preferred embodiment, solely 1,6-diisocyanatohexane is used as aliphatic diisocyanate A).

Suitable aliphatic diols B) are all organic diols known to the person skilled in the art that have a molecular weight of 62 g/mol to 120 g/mol. The diols and/or precursor compounds thereof may have been obtained from fossil or biological sources. The aliphatic diols for formation of the thermoplastic polyurethane polymer according to the invention are preferably selected from the group consisting of ethane-1,2-diol, propane-1,2-diol, propane-1,3-diol, butane-1,2-diol, butane-1,3-diol, butane-1,4-diol, pentane-1,2-diol, pentane-1,3-diol, pentane-1,4-diol, pentane-1,5-diol, hexane-1,2-diol, hexane-1,3-diol, hexane-1,4-diol, hexane-1,5-diol, hexane-1,6-diol or mixtures of at least two of these.

In a preferred embodiment, the one or more aliphatic diols B) are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least two of these. In a further preferred embodiment, propane-1,3-diol, butane-1,4-diol, hexane-1,6-diol and/or mixtures of at least two of these are used as aliphatic diols B). In a further preferred embodiment, butane-1,4-diol and/or hexane-1,6-diol are used as aliphatic diols B). In another preferred embodiment, solely butane-1,4-diol is used as aliphatic diol.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) one or more aliphatic diols selected from the group consisting of propane-1,3-diol, butane-1,4-diol, hexane-1,6-diol or mixtures of at least two of these,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) butane-1,4-diol,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and butane-1,4-diol B), based on the total mass of the formation components used, wherein the one or more aliphatic diisocyanates A) and butane-1,4-diol B) are used in a molar ratio in the range from 1.0:0.95 to 0.95:1.0, characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of 1,6-diisocyanatohexane A) and butane-1,4-diol B), based on the total mass of the formation components used, wherein 1,6-diisocyanatohexane A) and butane-1,4-diol B) are used in a molar ratio in the range from 1.0:0.95 to 0.95:1.0, characterized in that the M̅_{z}/M̅ₚₑₐₖ ratio of the thermoplastic polyurethane is within a range from 3 to 15, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, preferably within a range from 3 to 14, preferably within a range from 3.5 to 14, more preferably within a range from 3.5 to 13, even more preferably within a range from 3.5 to 12.5, even more preferably still within a range from 3.5 to 12, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) one or more aliphatic diols selected from the group consisting of propane-1,3-diol, butane-1,4-diol, hexane-1,6-diol or mixtures of at least two of these,

wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that the M̅_{z}/M̅ₚₑₐₖ ratio of the thermoplastic polyurethane is within a range from 3 to 15, preferably within a range from 3 to 14, preferably within a range from 3.5 to 14, more preferably within a range from 3.5 to 13, even more preferably within a range from 3.5 to 12.5, even more preferably still within a range from 3.5 to 12, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) butane-1,4-diol,

wherein the formation components used to produce the thermoplastic polyurethane polymer consist to an extent of at least 95% by weight of one or more aliphatic diisocyanates A) and butane-1,4-diol B), based on the total mass of the formation components used, wherein the one or more aliphatic diisocyanates A) and butane-1,4-diol B) are used in a molar ratio in the range from 1.0:0.95 to 0.95:1.0, characterized in that the M̅_{z}/M̅ₚₑₐₖ ratio of the thermoplastic polyurethane is within a range from 3 to 15, preferably within a range from 3 to 14, preferably within a range from 3.5 to 14, more preferably within a range from 3.5 to 13, even more preferably within a range from 3.5 to 12.5, even more preferably still within a range from 3.5 to 12, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

wherein the formation components used to produce the thermoplastic polyurethane polymer consist to an extent of at least 95% by weight of 1,6-diisocyanatohexane A) and butane-1,4-diol B), based on the total mass of the formation components used, wherein 1,6-diisocyanatohexane A) and butane-1,4-diol B) are used in a molar ratio in the range from 1.0:0.95 to 0.95:1.0, characterized in that the M̅_{z}/M̅ₚₑₐₖ ratio of the thermoplastic polyurethane is within a range from 3 to 15, preferably within a range from 3 to 14, preferably within a range from 3.5 to 14, more preferably within a range from 3.5 to 13, even more preferably within a range from 3.5 to 12.5, even more preferably still within a range from 3.5 to 12, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 100 000 g/mol to 900 000 g/mol, preferably within a range from 110 000 g/mol to 850 000 g/mol, more preferably within a range from 120 000 g/mol to 800 000 g/mol, even more preferably within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) one or more aliphatic diols selected from the group consisting of propane-1,3-diol, butane-1,4-diol, hexane-1,6-diol or mixtures of at least two of these,

wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 100 000 g/mol to 900 000 g/mol, preferably within a range from 110 000 g/mol to 850 000 g/mol, more preferably within a range from 120 000 g/mol to 800 000 g/mol, even more preferably within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) butane-1,4-diol,

wherein the formation components used to produce the thermoplastic polyurethane polymer consist to an extent of at least 95% by weight of one or more aliphatic diisocyanates A) and butane-1,4-diol B), based on the total mass of the formation components used, wherein the one or more aliphatic diisocyanates A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 100 000 g/mol to 900 000 g/mol, preferably within a range from 110 000 g/mol to 850 000 g/mol, more preferably within a range from 120 000 g/mol to 800 000 g/mol, even more preferably within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

wherein the formation components used to produce the thermoplastic polyurethane polymer consist to an extent of at least 95% by weight of 1,6-diisocyanatohexane A) and butane-1,4-diol B), based on the total mass of the formation components used, wherein 1,6-diisocyanatohexane A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 100 000 g/mol to 900 000 g/mol, preferably within a range from 110 000 g/mol to 850 000 g/mol, more preferably within a range from 120 000 g/mol to 800 000 g/mol, even more preferably within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 14, preferably within a range from 3.5 to 14, more preferably within a range from 3.5 to 13, even more preferably within a range from 3.5 to 12.5, even more preferably still within a range from 3.5 to 12, and (ii) the M̅_{z} of the thermoplastic polyurethane is within a range from 100 000 g/mol to 900 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) one or more aliphatic diols selected from the group consisting of propane-1,3-diol, butane-1,4-diol, hexane-1,6-diol or mixtures of at least two of these,

wherein the formation components used to produce the thermoplastic polyurethane polymer consist to an extent of at least 95% by weight of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 14, preferably within a range from 3.5 to 14, more preferably within a range from 3.5 to 13, even more preferably within a range from 3.5 to 12.5, even more preferably still within a range from 3.5 to 12, and (ii) the M̅_{z} of the thermoplastic polyurethane is within a range from 100 000 g/mol to 900 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) butane-1,4-diol,

wherein the formation components used to produce the thermoplastic polyurethane polymer consist to an extent of at least 95% by weight of one or more aliphatic diisocyanates A) and butane-1,4-diol B), based on the total mass of the formation components used, wherein the one or more aliphatic diisocyanates A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 14, preferably within a range from 3.5 to 14, more preferably within a range from 3.5 to 13, even more preferably within a range from 3.5 to 12.5, even more preferably still within a range from 3.5 to 12, and (ii) the M̅_{z} of the thermoplastic polyurethane is within a range from 100 000 g/mol to 900 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

wherein the formation components used to produce the thermoplastic polyurethane polymer consist to an extent of at least 95% by weight of 1,6-diisocyanatohexane A) and butane-1,4-diol B), based on the total mass of the formation components used, wherein 1,6-diisocyanatohexane A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3 to 14, preferably within a range from 3.5 to 14, more preferably within a range from 3.5 to 13, even more preferably within a range from 3.5 to 12.5, even more preferably still within a range from 3.5 to 12, and (ii) the M̅_{z} of the thermoplastic polyurethane is within a range from 100 000 g/mol to 900 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 14, and (ii) the M̅_{z} of the thermoplastic polyurethane is within a range of 110 000 g/mol to 850 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) one or more aliphatic diols selected from the group consisting of propane-1,3-diol, butane-1,4-diol, hexane-1,6-diol or mixtures of at least two of these,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 14, and (ii) the M̅_{z} of the thermoplastic polyurethane is within a range from 110 000 g/mol to 850 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) butane-1,4-diol,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and butane-1,4-diol B), based on the total mass of the formation components used, wherein the one or more aliphatic diisocyanates A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 14, and (ii) the M̅_{z} of the thermoplastic polyurethane is within a range from 110 000 g/mol to 850 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of 1,6-diisocyanatohexane A) and butane-1,4-diol B), based on the total mass of the formation components used, wherein 1,6-diisocyanatohexane A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 14, and (ii) the M̅_{z} of the thermoplastic polyurethane is within a range from 110 000 g/mol to 850 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these, wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 12, and (ii) the M̅_{z} of the thermoplastic polyurethane is within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) one or more aliphatic diols selected from the group consisting of propane-1,3-diol, butane-1,4-diol, hexane-1,6-diol or mixtures of at least two of these,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and one or more aliphatic diols B), based on the total mass of the formation components used, wherein the one or more aliphatic diisocyanates A) and the one or more aliphatic diols B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 12, and (ii) the M̅_{z} of the thermoplastic polyurethane is within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,5-diisocyanatopentane, 1,6-diisocyanatohexane or a mixture of these and

B) butane-1,4-diol,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates A) and butane-1,4-diol B), based on the total mass of the formation components used, wherein the one or more aliphatic diisocyanates A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 12, and (ii) the M̅_{z} of the thermoplastic polyurethane is within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of 1,6-diisocyanatohexane A) and butane-1,4-diol B), based on the total mass of the formation components used, wherein 1,6-diisocyanatohexane A) and butane-1,4-diol B) are used in a molar ratio in the range from 1.0:0.95 to 0.95:1.0, characterized in that (i) the M̅_{z}/M̅ₚₑₐₖ ratio of the thermoplastic polyurethane is within a range from 3.5 to 12, and (ii) the M̅_{z} of the thermoplastic polyurethane is within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

Further formation components used for production of the thermoplastic polyurethane polymers may, as well as the at least one or more than one aliphatic diisocyanate A) and the one or more than one aliphatic diol B), also be one or more polyisocyanates C) and/or one or more further NCO-reactive compounds D). These further formation components C) and/or D) are different from the formation components A) and B) and may be used in an amount of 0% by weight to 5% by weight. In a preferred embodiment, the formation components used for production of the thermoplastic polyurethane polymer consist to an extent of 0.1% by weight to 5% by weight of one or more polyisocyanates C) and/or one or more NCO-reactive compounds D), based on the total mass of the formation components used. The isocyanate components A) and optionally C) are used with the isocyanate-reactive components B) and optionally D) in a molar ratio of isocyanate component:isocyanate-reactive component in the range from 1.0:0.95 to 0.95:1.0.

In a further preferred embodiment, the thermoplastic polyurethane polymer according to the invention is obtainable by the reaction of at least the following formation components:

A) one or more aliphatic diisocyanates having a molecular weight of 140 g/mol to 170 g/mol,

B) one or more aliphatic diols having a molecular weight of 62 g/mol to 120 g/mol,

C) one or more polyisocyanates, and/or

D) one or more NCO-reactive compounds,

wherein the formation components used to produce the thermoplastic polyurethane polymer consist to an extent of at least 95% by weight of one or more aliphatic diisocyanates A) and one or more aliphatic diols B) and to an extent of ≤5% by weight of one or more polyisocyanates C) and/or one or more NCO-reactive compounds D), based on the total mass of the formation components used.

In a further preferred embodiment, the thermoplastic polyurethane polymer according to the invention is obtainable by the reaction of the following formation components:

A) one or more aliphatic diisocyanates having a molecular weight of 140 g/mol to 170 g/mol,

B) one or more aliphatic diols having a molecular weight of 62 g/mol to 120 g/mol,

C) one or more polyisocyanates, and/or

D) one or more NCO-reactive compounds,

wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more polyisocyanates C) and/or one or more NCO-reactive compounds D), based on the total mass of the formation components used.

Suitable polyisocyanates C) for formation of the polyurethane polymer according to the invention are all aliphatic, cycloaliphatic, aromatic and aliphatic di- and triisocyanates that are known per se to the person skilled in the art, it being immaterial whether these have been obtained by means of phosgenation or by phosgene-free methods. In addition, it is also possible to use the following higher molecular weight conversion products that are well known per se to the person skilled in the art: higher molecular weight conversion products (oligo- and polyisocyanates and prepolymers having NCO groups, especially polyurethane prepolymers having NCO groups) of monomeric di- and/or triisocyanates having urethane, urea, carbodiimide, acylurea, isocyanurate, allophanate, biuret, oxadiazinetrione, uretdione, iminooxadiazinedione structure, each individually or in any mixtures with one another. Preferred polyisocyanates C) are monomeric diisocyanates having a molecular weight of ≥140 g/mol to ≤400 g/mol.

Examples of suitable aliphatic diisocyanates are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane and 1,10-diisocyanatodecane.

Examples of suitable cycloaliphatic diisocyanates are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

Examples of suitable aromatic diisocyanates are 2,4- and 2,6-diisocyanatotoluene (TDI), 2,4′- and 4,4′-diisocyanatodiphenylmethane (MDI) and 1,5-diisocyanatonaphthalene.

Examples of suitable araliphatic diisocyanates are 1,3- and 1,4-bis(isocyanatomethyl)benzene (xylylene diisocyanate; XDI), 1,3- and 1,4-bis(1-isocyanato-1-methylethyl)benzene (TMXDI).

Examples of suitable triisocyanates are triphenylmethane 4,4′,4″-triisocyanate or 4-isocyanatomethyloctane 1,8-diisocyanate (TIN).

Further diisocyanates that are likewise suitable can additionally be found, for example, in Houben-Weyl “Methoden der organischen Chemie” [Methods of Organic Chemistry], volume E20 “Makromolekulare Stoffe” [Macromolecular Materials], Georg Thieme Verlag, Stuttgart, New York 1987, pp. 1587-1593 or in Justus Liebigs Annalen der Chemie volume 562 (1949) pp. 75-136.

Suitable NCO-reactive compounds D) for formation of the polyurethane polymer according to the invention are all organic compounds that are known per se to the person skilled in the art and have at least two isocyanate-reactive (NCO-reactive) groups (NCO-reactive compound or isocyanate-reactive compound). In the context of the present invention, NCO-reactive groups are considered to be especially hydroxyl, amino or thio groups. For the purposes of the invention, it is also possible to use a mixture of different NCO-reactive compounds for formation of the at least one further structural element (S).

NCO-reactive compounds D) used may be all systems having an average of at least 1.5, preferably 2 to 3 and more preferably 2 NCO-reactive groups.

Suitable isocyanate-reactive compounds are, for example, aliphatic, araliphatic or cycloaliphatic diols, organic triols, polyester polyols, polyether polyols, polycarbonate polyols, poly(meth)acrylate polyols, polyurethane polyols and polyamines.

Examples of aliphatic, araliphatic or cycloaliphatic diols are ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, decane-1,10-diol, undecane-1,11-diol, dodecane-1,12-diol, cyclobutane-1,3-diol, cyclopentane-1,3-diol, cyclohexane-1,2-, -1,3- and -1,4-diol, cyclohexane-1,4-dimethanol, 2-cyclohexene-1,4-diol, 2-methylcyclohexane-1,4-diol, 2-ethylcyclohexane-1,4-diol, 2,2,4,4-tetramethylcyclobutane-1,3-diol, hydrogenated bisphenol A (2,2-bis(4-hydroxycyclohexyl)propane), cycloheptane-1,3-diol, cycloheptane-1,4-diol, 2-methylcycloheptane-1,4-diol, 4-methylcycloheptane-1,3-diol, 4,4′-(1-methylethylidene)biscyclohexanol, cyclooctane-1,3-diol, cyclooctane-1,4-diol, cyclooctane-1,5-diol, 5-methylcyclooctane-1,4-diol, 5-ethylcyclooctane-1,4-diol, 5-propylcyclooctane-1,4-diol, 5-butylcyclooctane-1,4-diol and benzene-1,2-dimethanol.

Examples of organic triols are glycerol and trimethylolpropane.

Preference is given to using aliphatic, araliphatic or cycloaliphatic diols having molecular weights of 62 g/mol to 250 g/mol.

Suitable polyester polyols can be prepared in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, 1,4-dihydroxycyclohexane, 1,4-dimethylolcyclohexane, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. In addition, it is also possible to polycondense hydroxycarboxylic acid derivatives, for example lactic acid, cinnamic acid or ω-hydroxycaproic acid, to give polyester polyols. However, it is also possible to use polyester polyols of oleochemical origin. Such polyester polyols can be prepared, for example, by full ring-opening of epoxidized triglycerides of an at least partly olefinically unsaturated fatty acid-containing fat mixture with one or more alcohols having 1 to 12 carbon atoms and by subsequent partial transesterification of the triglyceride derivatives to alkyl ester polyols having 1 to 12 carbon atoms in the alkyl radical.

Suitable polyether polyols are obtainable in a manner known per se by alkoxylation of suitable starter molecules under base catalysis or by the use of double metal cyanide compounds (DMC compounds). The polyether polyols are polyaddition products, optionally of blockwise construction, of cyclic ethers onto OH- or NH-functional starter molecules. Suitable cyclic ethers are, for example, styrene oxides, ethylene oxide, propylene oxide, tetrahydrofuran, butylene oxide, epichlorohydrin and any desired mixtures thereof. Starter molecules used may be the polyhydric alcohols of OH functionality≥2 mentioned above in the context of the discussion of the polyester polyols, and also primary or secondary amines and amino alcohols. Suitable and preferred polyether polyols are di-, tri- and tetraethylene glycol, and di-, tri- and tetrapropylene glycol.

Suitable polycarbonate polyols are obtainable in a manner known per se by reacting organic carbonates or phosgene with diols or diol mixtures. Organic carbonates suitable for the purpose are, for example, dimethyl carbonate, diethyl carbonate and diphenyl carbonate. Suitable polyhydric alcohols include the polyhydric alcohols of OH functionality≥2 mentioned above in the context of the discussion of the polyester polyols. Preference is given to using butane-1,4-diol, hexane-1,6-diol and/or 3-methylpentanediol. Polyester polyols may also be transformed to polycarbonate polyols. Particular preference is given to using dimethyl carbonate or diethyl carbonate in the conversion of the alcohols mentioned to polycarbonate polyols.

Suitable polyacrylate polyols are generally copolymers and preferably have mass-average molecular weights Mw between 1000 daltons and 10 000 daltons. The preparation of suitable polyacrylate polyols is known to the person skilled in the art. They are obtained by free-radical polymerization of olefinically unsaturated monomers having hydroxyl groups or by free-radical copolymerization of olefinically unsaturated monomers having hydroxyl groups with optionally other olefinically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate. Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate. Further monomer units used for the polyacrylate polyols may be vinylaromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

Suitable polyurethane polyols are, for example, hydroxy-terminated prepolymers formed from the above-described diisocyanates and diols. As well as urethane groups, the polyurethane polyols may also contain urea, carbodiimide, acylurea, isocyanurate, allophanate, biuret, oxadiazinetrione, uretdione, iminooxadiazinedione structures. The polyurethane polyols are preparable by reaction of diisocyanates with diols by preparation processes known to the person skilled in the art.

Examples of polyamines are ethylenediamine, 1,2-diaminopropane, 1,4-diaminobutane, 2-methylpentamethylenediamine, 1,6-diaminohexane, 2,2,4- or 2,4,4-trimethylhexamethylenediamine, 1,2-diaminocyclohexane, 1-amino-3,3,5-trimethyl-5-aminomethylcyclohexane (isophoronediamine, IPDA), 4,4′-diaminodicyclohexylmethane, polyaspartic esters as obtainable, for example, by the process of EP-B 0 403 921 by reaction of diamines with fumaric or maleic esters, or else polyether polyamines having aliphatically bonded primary amino groups.

The reaction of formation components A), B), optionally C) and/or optionally D) for production of the polyurethane polymer according to the invention may take place in the presence of one or more catalysts.

Suitable catalysts according to the invention are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organic metal compounds such as titanic esters, iron compounds, tin compounds, e.g. tin diacetate, tin dioctoate, tin dilaurate or the dialkyltin salts of aliphatic carboxylic acids such as dibutyltin diacetate, dibutyltin dilaurate or the like. Preferred catalysts are organic metal compounds, in particular titanic esters, iron compounds and/or tin compounds.

The catalyst is used in amounts of 0.001% by weight to 2.0% by weight, preferably of 0.005% by weight to 1.0% by weight, more preferably of 0.01% by weight to 0.1% by weight, based on the diisocyanate component. The catalyst can be used in neat form or dissolved in the diol component. One advantage here is that the thermoplastic polyurethanes that are then obtained do not contain any impurities as a result of any solvents for the catalyst that are used in addition. The catalyst can be added in one or more portions or else continuously, for example with the aid of a suitable metering pump, over the entire duration of the reaction.

Alternatively, it is also possible to use mixtures of the catalyst(s) with a catalyst solvent, preferably with an organic catalyst solvent. The degree of dilution of the catalyst solutions can be chosen freely within a very wide range. Catalytically active solutions are those of a concentration over and above 0.001% by weight.

Suitable solvents for the catalyst are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxy-2-propyl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

Alternatively, it is possible to use solvents for the catalyst that bear groups reactive toward isocyanates and can be incorporated into the diisocyanate. Examples of such solvents are mono- and polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethyl allyl alcohol or oleyl alcohol; araliphatic alcohols, for example benzyl alcohol; N-monosubstituted amides, for example N-methylformamide, N-methylacetamide, cyanoacetamide or 2-pyrrolidone, or any desired mixtures of such solvents.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these,

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

C) one or more monomeric diisocyanates having a molecular weight of 140 g/mol to 400 g/mol,

D) one or more NCO-reactive compounds selected from the group consisting of aliphatic diols, araliphatic diols, cycloaliphatic diols, organic triols, polyester polyols, polyether polyols, polycarbonate polyols, poly(meth)acrylate polyols, polyurethane polyols, polyamines and/or mixtures of at least two of these,

wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that the M̅_{z}/M̅ₚₑₐₖ ratio of the thermoplastic polyurethane is within a range from 3 to 15, preferably within a range from 3 to 14, preferably within a range from 3.5 to 14, more preferably within a range from 3.5 to 13, even more preferably within a range from 3.5 to 12.5, even more preferably still within a range from 3.5 to 12, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

C) one or more monomeric diisocyanates having a molecular weight of 140 g/mol to 400 g/mol,

D) one or more NCO-reactive compounds selected from the group consisting of aliphatic, araliphatic or cycloaliphatic diols having molecular weights of 62 g/mol to 250 g/mol and/or mixtures of at least two of these,

wherein the formation components used to produce the thermoplastic polyurethane polymer consist to an extent of 95% by weight to 99.9% by weight of 1,6-diisocyanatohexane A) and butane-1,4-diol B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that the M̅_{z}/M̅ₚₑₐₖ ratio of the thermoplastic polyurethane is within a range from 3 to 15, preferably within a range from 3 to 14, preferably within a range from 3.5 to 14, more preferably within a range from 3.5 to 13, even more preferably within a range from 3.5 to 12.5, even more preferably still within a range from 3.5 to 12, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these,

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

C) one or more monomeric diisocyanates having a molecular weight of 140 g/mol to 400 g/mol,

D) one or more NCO-reactive compounds selected from the group consisting of aliphatic diols, araliphatic diols, cycloaliphatic diols, organic triols, polyester polyols, polyether polyols, polycarbonate polyols, poly(meth)acrylate polyols, polyurethane polyols, polyamines and/or mixtures of at least two of these,

wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 100 000 g/mol to 900 000 g/mol, preferably within a range from 110 000 g/mol to 850 000 g/mol, more preferably within a range from 120 000 g/mol to 800 000 g/mol, even more preferably within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

C) one or more monomeric diisocyanates having a molecular weight of 140 g/mol to 400 g/mol,

D) one or more NCO-reactive compounds selected from the group consisting of aliphatic, araliphatic or cycloaliphatic diols having molecular weights of 62 g/mol to 250 g/mol and/or mixtures of at least two of these,

wherein the formation components used to produce the thermoplastic polyurethane polymer consist to an extent of 95% by weight to 99.9% by weight of 1,6-diisocyanatohexane A) and butane-1,4-diol B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 100 000 g/mol to 900 000 g/mol, preferably within a range from 110 000 g/mol to 850 000 g/mol, more preferably within a range from 120 000 g/mol to 800 000 g/mol, more preferably still within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-disocyanatopentane and/or mixtures of at least two of these,

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

C) one or more monomeric diisocyanates having a molecular weight of 140 g/mol to 400 g/mol,

D) one or more NCO-reactive compounds selected from the group consisting of aliphatic diols, araliphatic diols, cycloaliphatic diols, organic triols, polyester polyols, polyether polyols, polycarbonate polyols, poly(meth)acrylate polyols, polyurethane polyols, polyamines and/or mixtures of at least two of these,

wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3 to 14, preferably within a range from 3.5 to 14, more preferably from 3.5 to 13, even more preferably within a range from 3.5 to 12.5, even more preferably still within a range from 3.5 to 12, and (ii) the M̅_{z} of the thermoplastic polyurethane is within a range from 100 000 g/mol to 900 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

C) one or more monomeric diisocyanates having a molecular weight of 140 g/mol to 400 g/mol,

D) one or more NCO-reactive compounds selected from the group consisting of aliphatic, araliphatic or cycloaliphatic diols having molecular weights of 62 g/mol to 250 g/mol and/or mixtures of at least two of these,

wherein the formation components used to produce the thermoplastic polyurethane polymer consist to an extent of 95% by weight to 99.9% by weight of 1,6-diisocyanatohexane A) and butane-1,4-diol B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3 to 14, preferably within a range from 3.5 to 14, more preferably from 3.5 to 13, even more preferably within a range from 3.5 to 12.5, even more preferably still within a range from 3.5 to 12, and (ii) the M̅_{z} of the thermoplastic polyurethane is within a range from 100 000 g/mol to 900 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these,

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

C) one or more monomeric diisocyanates having a molecular weight of 140 g/mol to 400 g/mol,

D) one or more NCO-reactive compounds selected from the group consisting of aliphatic diols, araliphatic diols, cycloaliphatic diols, organic triols, polyester polyols, polyether polyols, polycarbonate polyols, poly(meth)acrylate polyols, polyurethane polyols, polyamines and/or mixtures of at least two of these,

wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 110 000 g/mol to 850 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

C) one or more monomeric diisocyanates having a molecular weight of 140 g/mol to 400 g/mol,

D) one or more NCO-reactive compounds selected from the group consisting of aliphatic, araliphatic or cycloaliphatic diols having molecular weights of 62 g/mol to 250 g/mol and/or mixtures of at least two of these,

wherein the formation components used to produce the thermoplastic polyurethane polymer consist to an extent of 95% by weight to 99.9% by weight of 1,6-diisocyanatohexane A) and butane-1,4-diol B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3 to 15, and (ii) the M̅_{z} of the thermoplastic polyurethane is within a range from 110 000 g/mol to 850 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these,

B) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,

C) one or more monomeric diisocyanates having a molecular weight of 140 g/mol to 400 g/mol,

D) one or more NCO-reactive compounds selected from the group consisting of aliphatic diols, araliphatic diols, cycloaliphatic diols, organic triols, polyester polyols, polyether polyols, polycarbonate polyols, poly(meth)acrylate polyols, polyurethane polyols, polyamines and/or mixtures of at least two of these,

wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3.5 to 12, and (ii) the M̅_{z} of the thermoplastic polyurethane is within a range from 125 000 g/mol to 770 000 g/mol, where M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

In a further preferred embodiment, the thermoplastic polyurethane polymer according to the invention is obtainable by the reaction of at least the following formation components:

A) 1,6-diisocyanatohexane and

B) butane-1,4-diol,

C) one or more monomeric diisocyanates having a molecular weight of 140 g/mol to 400 g/mol,

D) one or more NCO-reactive compounds selected from the group consisting of aliphatic, araliphatic or cycloaliphatic diols having molecular weights of 62 g/mol to 250 g/mol and/or mixtures of at least two of these,

wherein the formation components used to produce the thermoplastic polyurethane polymer consist to an extent of 95% by weight to 99.9% by weight of 1,6-diisocyanatohexane A) and butane-1,4-diol B) and to an extent of 0.1% by weight to 5% by weight of one or more diisocyanates C) and/or one or more NCO-reactive compounds D), based on the total mass of the formation components used, where the diisocyanate components A) and optionally C) are used with the NCO-reactive components B) and optionally D) in a molar ratio of diisocyanate component:NCO-reactive component in the range from 1.0:0.95 to 0.95:1.0, characterized in that (i) the M̅_{z}/M̅ₚₑₐₖ ratio of the thermoplastic polyurethane is within a range from 3.5 to 12, and (ii) the M̅_{z} of the thermoplastic polyurethane is within a range from 125 000 g/mol to 770 000 g/mol, where M̅_{z} is the centrifuge-average molar mass and M̅_{z} peak is the molar mass of the maximum of the gel permeation chromatography curve, each determined by gel permeation chromatography in hexafluoroisopropanol against polymethylmethacrylate as standard.

In a preferred embodiment, the thermoplastic polyurethane polymer according to the invention has a urethane group content of 40% by weight to 60% by weight, preferably of 40% by weight to 52% by weight, based on the total weight of the thermoplastic polyurethane polymer. In a particularly preferred embodiment, the thermoplastic polyurethane polymer according to the invention has a urethane group content of 44% by weight to 48% by weight, even more preferably of 44% by weight to 46% by weight, based on the total weight of the thermoplastic polyurethane polymer.

The urethane group content is determined by dividing the mass of the (theoretical) linear repeat unit by the mass of the urethane structural unit. In this case, each isocyanate group (—NCO) is reacted with an alcohol group (—OH). The resulting value is multiplied by 100 in order to obtain a value in %.

Example calculation:

| | | Mass in g/mol |
|---|---|---|
| Diisocyanate | pentamethylene 1,5- | 154.17 |
| | diisocyanate | |
| Diol | butane-1,4-diol | 90.12 |
| Repeat unit | | 244.29 |
| Urethane group | | 59.02 |

Number of urethane groups theoretically present=2

Resulting urethane group density=48.32.

In a preferred embodiment, the thermoplastic polyurethane polymer according to the invention has a percent by weight ratio of O to N determined by means of elemental analysis of ≥1.5:1 to ≤2.6:1 and a percent by weight ratio of N to C determined by means of elemental analysis of ≥1:10 to ≤1:3.

In a further preferred embodiment, the thermoplastic polyurethane polymer according to the invention is a semicrystalline thermoplastic polyurethane polymer.

In a further preferred embodiment, the thermoplastic polyurethane polymer according to the invention has a glass transition point of <50° C., preferably in the range between ≥0° C. and <50° C., determined by means of differential scanning calorimetry to DIN EN 61006 (November 2004).

In a further preferred embodiment, the thermoplastic polyurethane polymer according to the invention has a melting point of >150° C., determined by means of differential scanning calorimetry to DIN EN 61006 (November 2004).

In a further preferred embodiment, the thermoplastic polyurethane polymer according to the invention has at least 100° C. between the glass transition point determined by means of differential scanning calorimetry to DIN EN 61006 (November 2004) and the melting point determined by means of differential scanning calorimetry to DIN EN 61006 (November 2004) of the thermoplastic polyurethane.

In a further preferred embodiment, the thermoplastic polyurethane according to the invention has a flexural stress in the range from 73 MPa to 79 MPa, determined to DIN EN ISO 178 (September 2013), conducted with an Instron 5566 universal tester at a speed of 5 mm/min, a fin radius of 5 mm and an application distance of 64 mm

The invention further provides for the preparation of the thermoplastic polyurethane polymer according to the invention. The preparation can be effected, for example, in a multistage process, wherein, in at least one stage, at least one prepolymer, preferably a hydroxy-terminated prepolymer, is formed from at least one aliphatic diisocyanate A) having a molecular weight of 140 g/mol to 170 g/mol and at least one aliphatic diol B) having a molecular weight of 62 g/mol to 120 g/mol. Further formation components used may be one or more polyisocyanates C) and/or one or more NCO-reactive compounds D). Components C) and D) may be incorporated into the prepolymers, prepolymers can be produced solely therefrom and/or they can be used to link the prepolymers. Components A), B), optionally C) and optionally D) are each selected independently of one another. The isocyanate components A) and optionally C) are used with the isocyanate-reactive components B) and optionally D) in a molar ratio of isocyanate component:isocyanate-reactive component in the range from 1.0:0.95 to 0.95:1.0.

In the context of the present invention, a “hydroxy-terminated prepolymer” is understood to mean a prepolymer mixture in which at least 90% (by number) of the ends of the molecule have a hydroxyl group and the remaining 10% (by number) of ends of the molecule have further hydroxyl groups, NCO groups or non-reactive groups. A “non-reactive group” in the context of the present invention is understood as meaning a group that, under the reaction conditions according to the invention, reacts neither with NCO groups nor with OH groups within a unit of time that corresponds to the reaction time according to the invention. A non-reactive group can be converted, for example, from a reactive NCO group or OH group by reaction with suitable co-reactants (chain terminator) to a non-reactive group. Suitable chain terminators are all monofunctional compounds that react under the reaction conditions according to the invention either with an isocyanate group or with a hydroxy group, for example monoalcohols such as methanol, monoamines such as diethylamine, and monoisocyanates such as butyl isocyanate. The hydroxy-terminated prepolymer may have, for example, a hydroxy group at one end of the molecule and, for example, an alkyl group at the other end(s) of the molecule. Where reference is made to a hydroxy-terminated prepolymer in the context of the present invention, this always means a mixture of the at least one hydroxy-terminated prepolymer and a non-reactively terminated prepolymer. In addition, on the basis of the statistics of the reaction, disregarding side reactions, it may also be a mixture of non-hydroxy-terminated up to doubly hydroxy-terminated prepolymers. Preferably, it is predominantly a mixture of doubly hydroxy-terminated prepolymers. According to the invention, the at least one hydroxy-terminated prepolymer may also be a mixture of at least one hydroxy-terminated prepolymer and at least one non-reactively terminated prepolymer.

In the context of the present invention, a “non-reactively terminated prepolymer” is understood to mean a prepolymer in which the reactive groups (NCO groups or OH groups) have been converted by reaction with suitable co-reactants (chain terminators) to chemical groups that do not react either with NCO groups or with OH groups under the reaction conditions mentioned. Examples of suitable chain terminators are monoalcohols such as methanol, monoamines such as diethylamine, and monoisocyanates such as butyl isocyanate. The molar proportion of the chain terminators may, for example, be from 0.001 mol % to 2 mol % and preferably from 0.002 mol % to 1 mol %, based in each case on the total molar amount of the corresponding monomer component.

The at least one hydroxy-terminated prepolymer may be formed, for example, from the entirety of the aliphatic diols B) and a first portion of the aliphatic diisocyanates A). In one or more subsequent steps, further portions of the aliphatic diisocyanates A), i.e. a second, third etc. portion, may then be added in order to form further hydroxy-terminated prepolymers, generally of higher molecular weight, according to the invention. Alternatively, the at least one hydroxy-terminated prepolymer may be formed, for example, from a first portion of the aliphatic diols B) and a first portion of the aliphatic diisocyanates A). In one or more subsequent process stages, further portions of the aliphatic diols B) and of the aliphatic diisocyanates A) may then be fed in in order to form further hydroxy-terminated prepolymers, generally of higher molecular weight.

The reaction can be performed with or without catalyst, but a catalysed reaction is less preferred. Suitable catalysts are the catalysts listed above. The reaction can be effected in a solvent-free manner or in solution. What is meant by “in solution” is that at least one of the co-reactants is dissolved in a solvent before being added to the other co-reactant. Preference is given to performing the reaction in a solvent-free manner. In the context of the present invention, the process is still considered to be solvent-free when the solvent content is up to 1% by weight, preferably up to 0.1% by weight, even more preferably up to 0.01% by weight, based on the total weight of the reaction mixture.

The temperatures for formation of the at least one prepolymer, preferably hydroxy-terminated prepolymer, by the process according to the invention can be selected depending on the compounds used. However, it is preferable here when the reaction is conducted at temperatures of ≥40° C. to ≤260° C., preferably of ≥60° C. to ≤250° C., more preferably of ≥100° C. to ≤240° C., especially preferably of ≥120° C. to ≤220° C. In this context, brief (<60 seconds) deviations in the reaction temperature from the abovementioned ranges experienced by the product during the reaction are tolerated.

The at least one prepolymer thus produced, preferably hydroxy-terminated prepolymer, may, for example, be reacted in at least one further process stage with at least one chain extender to give the thermoplastic polyurethane polymer. It is possible here to react either the entireties of the two components, i.e. of the at least one prepolymer generated, preferably hydroxy-terminated prepolymer, and of the at least one chain extender, with one another in one process stage, or to react a portion of one component with the entirety or a portion of the other component in multiple process stages. Chain extenders used may be any of the abovementioned polyisocyanates. Preference is given to using one or more aliphatic diisocyanates having a molecular weight of 140 g/mol to 170 g/mol as chain extender.

If the thermoplastic polyurethane polymer according to the invention is to have aromatic groups, for example, these may be introduced, for example, through the use of aromatic diisocyanates as chain extender. It is also possible, for example, to produce aromatic prepolymers and to mix these with the aliphatic prepolymers in order to form polyurethane polymers according to the invention that have aromatic groups.

The reaction of components A), B), optionally C) and optionally D) can be performed with or without catalyst, although a catalysed reaction is less preferred. Suitable catalysts are the catalysts listed above. The reaction can be effected in a solvent-free manner or in solution. What is meant by “in solution” is that at least one of the co-reactants is dissolved in a solvent before being added to the other co-reactant. Preference is given to performing the reaction in a solvent-free manner In the context of the present invention, the process is still considered to be solvent-free when the solvent content is up to 1% by weight, preferably up to 0.1% by weight, even more preferably up to 0.01% by weight, based on the total weight of the reaction mixture.

The temperatures for formation of the thermoplastic polyurethane polymer according to the invention by reaction of the at least one prepolymer, preferably hydroxy-terminated prepolymer, with the at least one chain extender in the process according to the invention may be selected depending on the compounds used. However, it is preferable here when the reaction is conducted at temperatures of ≥60° C. to ≤260° C., preferably of ≥80° C. to ≤250° C., more preferably of ≥100° C. to ≤245° C. and most preferably of ≥120° C. to ≤240° C. In this context, brief (<60 seconds) deviations in the reaction temperature from the abovementioned ranges experienced by the product during the reaction are tolerated.

If the at least one prepolymer, preferably hydroxy-terminated prepolymer, or the thermoplastic polyurethane polymer has a tendency to crystallize and has a melting point, the reaction is preferably conducted within a temperature range from 30 K below to 150 K above the melting point, preferably from 15 K below to 100 K above, more preferably from 10 K below to 70 K above, the melting point of the at least one prepolymer, preferably hydroxy-terminated prepolymer, or the thermoplastic polyurethane.

The process stages for production of the thermoplastic polyurethane polymer according to the invention can be performed in a single apparatus or in a multitude of apparatuses. For example, the production of the prepolymer, preferably hydroxy-terminated prepolymer, can first be conducted in a first apparatus (e.g. loop reactor or coolable mixer) and then the reaction mixture can be transferred into a further apparatus (e.g. extruder or other high-viscosity reactor) in order to produce the thermoplastic polyurethane polymer according to the invention.

In a preferred embodiment, the at least one aliphatic diol B) and the at least one aliphatic diisocyanate A) are reacted in at least one static mixer, dynamic mixer or mixer-heat transferrer to give the at least one hydroxy-terminated prepolymer.

In a further preferred embodiment, the at least one aliphatic diol B) and the at least one aliphatic diisocyanate A) are reacted in a loop reactor to give the at least one hydroxy-terminated prepolymer.

For reaction of the at least one prepolymer, preferably hydroxy-terminated prepolymer, with the at least one chain extender to give the thermoplastic polyurethane polymer, it is necessary to match the process according to the invention to the exponential rise in viscosity in this phase. This is achieved preferably by using apparatuses in which the reaction product is actively moved by mechanical energy. Particular preference is given to using apparatuses in which the material surfaces clean one another—with allowance for clearance. Such apparatuses are, for example, co-rotating multi-screw extruders such as two-shaft or four-shaft extruders or ring extruders, co-rotating multi-screw extruders, co-kneaders or planetary roll extruders and rotor-stator systems. Further suitable apparatuses are single- or twin-shaft large-volume kneaders. The twin-shaft large-volume kneaders may be co- or counter-rotating. Examples of large-volume kneaders are, for example, CRP (from List Technology AG), Reacom (Buss-SMS-Canzler GmbH), Reasil (Buss-SMS-Canzler GmbH), KRC kneader (Kurimoto, Ltd). In a preferred embodiment, at least one such apparatus is combined with at least one static mixer, dynamic mixer, loop reactor or mixer-heat transferrer, in which case the at least one prepolymer, preferably hydroxy-terminated prepolymer, is produced from the at least one aliphatic diol B) and the at least one aliphatic diisocyanate A) in the static mixer, dynamic mixer, loop reactor or mixer-heat transferrer. If any of the components in the reaction mixture has a tendency to crystallize, the temperature of the mixture is kept by suitable measures within a temperature range from 30 K below to 150 K above the melting point, preferably from 15 K below to 100 K above, more preferably from 10 K below to 70 K above, the melting point of the component that melts at the highest temperature or of the reaction product of the components that melts at the highest temperature. The residence time in the static mixer, dynamic mixer, loop reactor or mixer-heat transferrer is preferably sufficiently short here that the rise in viscosity (caused by the polyaddition reaction of the reactive components with one another) does not lead to blockage of the static mixer, dynamic mixer, loop reactor or mixer-heat transferrer or any increase in pressure is limited to <50 bar, preferably <30 bar, more preferably <20 bar and most preferably <10 bar, and the mixture formed is fed to an apparatus that corresponds to the list above.

In a further preferred embodiment, the reaction of the at least one prepolymer, preferably hydroxy-terminated prepolymer, with the at least one chain extender takes place in an extruder.

In a further preferred embodiment, the preparation of the thermoplastic polyurethane polymer according to the invention takes place in a combination of a loop reactor with an extruder.

In a further preferred embodiment, the preparation of the thermoplastic polyurethane polymer according to the invention takes place in a combination of a static mixer, dynamic mixer, loop reactor or mixer-heat transferrer with a heated conveyor belt.

After the reaction to give the thermoplastic polyurethane polymer according to the invention, it is converted to a commercial form, typically pellets. After the conversion in the final process stage, the thermoplastic polyurethane polymer according to the invention is in the molten state, is comminuted in the molten state and is made to solidify by cooling, or is first made to solidify by cooling and then comminuted. This can be accomplished, for example, by the methods of strand pelletization, underwater strand pelletization, water-ring pelletization and underwater pelletization that are known to the person skilled in the art. Cooling is preferably effected with water; cooling with air or other media is also possible.

After conversion in a belt reactor, the thermoplastic polyurethane polymer according to the invention can also be cooled, crushed and ground.

According to the invention, the thermoplastic polyurethane polymer according to the invention thus obtained can be mixed in a solid-state mixing process and melted and pelletized again in a further extruder. This is preferable particularly when thermoplastic polyurethane polymer according to the invention is cooled and ground downstream of the belt reactor because this operation also homogenizes the product form.

The preparation process according to the invention can be performed continuously or batchwise, i.e. as a batchwise process or semibatchwise process.

The thermoplastic polyurethane polymer according to the invention that has been prepared by the process according to the invention can be processed to give shaped bodies, such as extruded articles and injection-moulded articles, films, thermoplastic foams, fibres or powders.

In a preferred embodiment of the process according to the invention for preparation of the thermoplastic polyurethane polymer according to the invention, in a first step, at least one or more than one aliphatic diisocyanate A) having a molecular weight of 140 g/mol to 170 g/mol is reacted with one or more aliphatic diols B) having a molecular weight of 62 g/mol to 120 g/mol to give at least one prepolymer, preferably to give at least one hydroxy-terminated prepolymer, and the at least one prepolymer obtained in the first step is reacted in a second step with at least one chain extender, preferably at least one diisocyanate, to give the thermoplastic polyurethane polymer according to the invention.

Chain extenders used may, depending on the prepolymer formed, be organic diols, diamines and polyisocyanates. In the case of NCO-terminated prepolymers, suitable examples include organic diols and diamines each having a molecular weight of 60 g/mol to 120 g/mol. Preferred chain extenders are aliphatic diols having a molecular weight of 62 g/mol to 120 g/mol, for example ethane-1,2-diol, propane-1,2-diol, propane-1,3-diol, butane-1,2-diol, butane-1,3-diol, butane-1,4-diol, pentane-1,5-diol, hexane-1,6-diol, ethane-1,2-diamine and propane-1,3-diamine. In a preferred embodiment of the process according to the invention for preparation of the thermoplastic polyurethane polymer, butane-1,4-diol is used as chain extender. In the case of hydroxy-terminated prepolymers, suitable examples are polyisocyanates having a molecular weight of 140 g/mol to 170 g/mol, preferably aliphatic diisocyanates having a molecular weight of 140 g/mol to 170 g/mol, for example 1,4-diisocyanatobutane, 1,5-diisocyanatopentane, 1,6-diisocyanatohexane and 2-methyl-1,5-diisocyanatopentane. In a preferred embodiment of the process according to the invention for preparation of the thermoplastic polyurethane polymer, 1,6-diisocyanatohexane and/or 1,5-diisocyanatopentane is used as chain extender.

The invention also provides compositions comprising at least one thermoplastic polyurethane polymer according to the invention and at least one additive or a further thermoplastic polymer.

The additives may be for example standard additives in the field of thermoplastic technology, such as dyes, fillers, processing auxiliaries, plasticizers, nucleating agents, stabilizers, flame retardants, demoulding agents or reinforcing additives. Further details on the additives mentioned may be found in the specialist literature, for example in the monograph by J. H. Saunders and K. C. Frisch “High Polymers”, volume XVI, Polyurethane [Polyurethanes], part 1 and 2, Interscience Publishers 1962/1964, in “Taschenbuch für Kunststoff-Additive” [Plastics Additives Handbook] by R. Gächter and H. Müller (Hanser Verlag Munich 1990) or in DE-A 29 01 774. Of course, it may likewise be advantageous to use two or more additives of two or more types.

Suitable thermoplastic polymers that may be part of the composition according to the invention are, for example, poly styrenes, polyamide s, polyethylene, polypropylene, polyacrylates, polymethacrylates, polyurethanes or else acrylonitrile-butadiene-styrene copolymers (ABS).

The compositions according to the invention can be used to produce thermoplastic moulding compounds. The invention therefore further provides a thermoplastic moulding compound comprising at least one composition according to the invention. The thermoplastic moulding compounds according to the invention may be produced, for example, by mixing the respective constituents of the compositions in a known manner and melt-compounding and melt-extruding the constituents at temperatures of preferably 180° C. to 320° C., more preferably at 200° C. to 300° C., in customary apparatuses, for example internal kneaders, extruders and twin-shaft screw systems. In the context of the present application, this process is generally referred to as compounding.

What is meant by “moulding compound” is thus the product obtained when the constituents of the composition are melt-compounded or melt-extruded.

The individual constituents of the compositions can be mixed in a known manner, either successively or simultaneously, either at about 20° C. (room temperature) or at higher temperature. This means, for example, that some of the constituents can be metered in via the main intake of an extruder and the remaining constituents can be fed in later in the compounding process via a side extruder.

The invention also provides a process for producing the moulding compounds according to the invention.

The thermoplastic moulding compounds according to the invention may be used to produce mouldings, films and/or fibres of any kind. The invention therefore further provides a moulding, a film and/or a fibre, wherein the moulding, film or fibre comprises at least one thermoplastic polyurethane polymer according to the invention, at least one thermoplastic moulding compound according to the invention or at least one composition according to the invention. These may be produced, for example, by injection moulding, extrusion, blow-moulding methods and/or melt spinning A further form of processing is the production of mouldings by thermoforming from previously produced sheets or films.

It is also possible to meter the constituents of the compositions directly into an injection moulding machine or into an extrusion unit and to process them to give mouldings.

The invention further provides for the use of a thermoplastic polyurethane polymer according to the invention for production of a composition or a thermoplastic moulding compound.

The invention further provides for the use of a composition according to the invention for production of a thermoplastic moulding compound.

The invention further provides for the use of a thermoplastic polyurethane polymer according to the invention, of a thermoplastic moulding compound according to the invention or of a composition according to the invention for production of a moulding, a film and/or a fibre.

The invention is to be elucidated in detail by the examples which follow, but without restricting it thereto.

The figures and examples elucidated hereinafter serve to further elucidate the invention, but these merely constitute illustrative examples of particular embodiments, and not a restriction of the scope of the invention. The individual figures show:

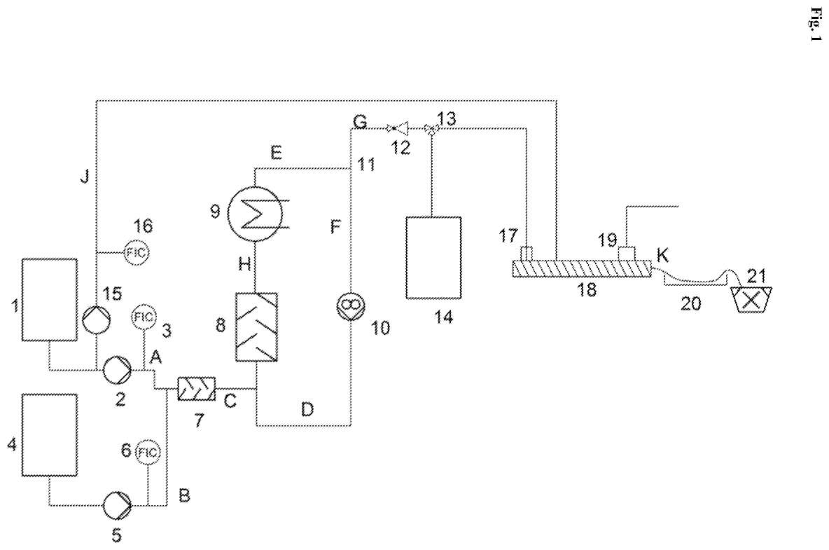

FIG. 1: Preferred embodiment of a construction for performance of a two-stage continuous preparation of a thermoplastic polyurethane according to the invention, by reaction sequence in loop reactor and extruder.

### EXAMPLES

All percentages are based on weight, unless stated otherwise.

The ambient temperature of 25° C. at the time of performing the experiments is referred to as RT (room temperature).

Raw Materials Used:

Hexamethylene 1,6-diisocyanate (HDI, purity≥99% by weight) was sourced from Covestro AG.

Butane-1,4-diol (BDO, purity≥99% by weight) was sourced from Ashland.

Hexafluoroisopropanol was sourced from flurochem in a purity of 99.9% by weight.

Potassium trifluoroacetate sourced from Aldrich, in a purity of 98% by weight.

Gel Permeation Chromatography:

The molar masses of the polymers were determined with the aid of gel permeation chromatography (GPC). For this purpose, the sample to be analysed was dissolved in a solution of 3 g of potassium trifluoroacetate in 400 cubic centimetres of hexafluoroisopropanol (sample concentration about 2 mg/cubic centimetre). The respective GPCs were measured with the following components at a flow rate of 1 cubic centimetre/minute:

| | |
|---|---|
| Pump: | 515 HPLC pump (Waters GmbH) |
| Detector: | Smartline 2300 RI detector (Knauer |
| | Wissenschaftliche Geräte |
| Columns: | 1 pre-column, 1000 Å PSS PFG 7 μm, |
| | 300 Å PSS PFG 7 μm, 100 Å PSS PFG |
| | 7 μm in the sequence specified |
| Degassing: | PSS degasser (Polymer Standards Service |
| | GmbH) |
| Injection volume: | 100 microlitres |
| Temperature: | 23° C.-25° C. |
| Molar mass standard: | Polymethylmethacrylate standard kit (PSS |
| | Polymer Standards Service GmbH) |

Calculation of M̅_{z} and M̅ₚₑₐₖ:

The centrifuge-average molar mass (M̅_{z}) was calculated from the data obtained by the gel permeation chromatography measurement with the aid of the following equation:

$${\overline{M}}_{z} = \frac{{\sum }_{i} {n}_{i} {M}_{i}^{3}}{{\sum }_{i} {n}_{i} {M}_{i}^{2}} in g / mol$$

Abbreviations:

Mᵢ is the molar mass of the polymers of the fraction i, such that Mᵢ<Mᵢ₊₁ for all i, in g/mol,

nᵢ is the molar amount of the polymer of the fraction i, in mol,

n is the total molar amount, n=Σᵢnᵢ, in mol,

mᵢ is the mass of the polymer of the fraction i, mᵢ=nᵢMᵢ, in g,

m_{g} is the total mass of the polymer, m_{g}=Σᵢmᵢ, in g,

$${w}_{i} = \frac{{m}_{i}}{{m}_{g}}$$

is the proportion by mass of the polymer in the fraction i.

As is known, molar mass distributions are typically plotted logarithmically against the molar mass, with the mass fractions to scale with the molar mass in order to assure area equality of the plot.

The peak molar mass, M̅ₚₑₐₖ, is found from the maximum of this logarithmic plot to be

M̅ₚₑₐₖ=Mₖ, such that wₖ Mₖ=max (wᵢ Mᵢ) for all i, in g/mol.

Differential Scanning Calorimetry (DSC)

Melting points and glass transition points were determined by means of DSC (differential scanning calorimetry) with a Mettler DSC 12E (Mettler Toledo GmbH, Giessen, Germany) in accordance with DIN EN 61006 (November 2004). Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 20 K/min. Cooling was effected by means of liquid nitrogen. The purge gas used was nitrogen. The values reported are each based on the evaluation of the 2nd heating curve.

Production of the Test Specimens:

The test specimens (80 mm×10 mm×4 mm bars) were produced by melting polymer pellets in a “Mikro Compounder Model 2005” from DSM Xplore. The processing temperature was set to 195° C. at 100 revolutions per minute. After a dwell time in the extruder of 2 minutes, the melt was transferred to the “Micro 10cc Injection Moulding Machine” from DSM Xplore. The injection mould was heated to 100° C. The injection moulding pressure was set to 6 bar (10 seconds). The hold pressure was 9 bar (10 seconds). The injection-moulded flexural specimens were manually demoulded after 20 seconds.

Determination of Maximum Flexural Stress:

Flexural stress was determined on the test specimens described above by means of a slow three-point bending test at room temperature to DIN EN ISO 178 (September 2013), conducted with an Instron 5566 universal tester at a speed of 5 mm/min, a fin radius of 5 mm and an application distance of 64 mm.

### Preparation of Comparative Example 1

In a stirred tank (250 ml), 53.02 g of butane-1,4-diol was stirred with 96.92 g of HDI at 23° C. Subsequently, the reaction vessel was purged with nitrogen and heated to 90° C. while stirring (170 revolutions per minute, rpm). Once the internal temperature of the stirred tank had risen to 90° C., the heating was removed. Over the course of the next 5 minutes, the internal temperature rose to 240° C. The experiment was ended as the reaction mixture could no longer be stirred, since the product had solidified.

### Preparation of Comparative Example 2

In a stirred tank (250 ml), 53.02 g of butane-1,4-diol was heated to 90° C. while stirring (170 rpm) with introduction of nitrogen for 30 minutes. Subsequently, 96.98 g of HDI was metered continuously into the butanediol over a period of 45 minutes. In the course of this, the temperature of the reaction mixture was increased constantly by 4° C. per minute until a temperature of 190° C. had been attained (25 minutes). As soon as a product temperature of 190° C. had been attained, the stirrer speed was increased to 300 rpm. The temperature in the stirred tank was kept constant between 190° C. and 200° C.

After the metered addition of HDI had ended, the melt was stirred for a further 5 minutes. Subsequently, it was poured into an aluminium mould in the hot state.

### Preparation of the Inventive Examples 1-5 (FIG. 1)

From a 250 litre reservoir for hexamethylene 1,6-diisocyanate 1, with the aid of a toothed ring pump 2 (from HNP, MZR 7255), a hexamethylene 1,6-diisocyanate stream A was conveyed to a static mixer 7. The throughput of the hexamethylene 1,6-diisocyanate stream A was measured by means of a mass flow meter 3 (from Bronkhorst, Mini Con-Flow M1X, max. flow rate 12 kg/h). From a 250 litre reservoir for butane-1,4-diol 4, with the aid of a toothed ring pump 5 (from HNP, MZR 7205), a butane-1,4-diol stream B was conveyed to the static mixer 7. The throughput of the butane-1,4-diol stream was measured by means of a mass flow meter 6 (from Bronkhorst, Mini Con-Flow M1X, max. flow rate 8 kg/h). The temperature of the hexamethylene 1,6-diisocyanate was room temperature. The temperature of the butane-1,4-diol was 40° C. In the static mixer 7 (Sulzer SMX, diameter 6 mm, ratio of length to diameter L/D=10), the hexamethylene 1,6-diisocyanate stream A and the butane-1,4-diol stream B were mixed with one another. This is stream C.

The mixed and dispersed stream C is mixed in a circulation system with a circulating polymer stream D in a static mixer 8 (static mixer equivalent to Sulzer SMX, internal diameter 34 mm, L/D=20) to give a stream H. The temperature of stream D was 182° C.

The mixed and already partly reacted stream H was guided into a temperature-controllable static mixer 9. The reaction proceeded there for the most part, and the heat of reaction that arose was removed. The temperature-controllable static mixer 9 was of similar construction to a Sulzer SMR reactor with internal crossed tubes. It had an internal volume of 1.9 litres, and a heat exchange area of 0.44 square metre. It was heated/cooled with heat carrier oil. The heating medium temperature at the inlet was 180° C.

The product stream left the temperature-controllable static mixer 9 as a largely reacted stream E with a temperature of 183° C. At a branch 11, stream E was split into two substreams F and G. The pressure of substream F was increased at a gear pump 10. Substream F became the abovementioned substream D downstream of the pump.

The gear pump 10 (from Witte Chem 25,6-3) had a volume per cycle of 25.6 cubic centimetres and a speed of 50 per minute.

The whole circulation system was filled completely, and the polymer was largely incompressible. Therefore, the mass flow rate of stream G was identical to that of stream C. Stream G consisted of oligomer.

The whole circulation system consisted of jacketed pipelines and apparatuses that were heated with thermal oil. The heating medium temperature was 182° C.

Beyond the pressure-retaining valve 12, stream G was run past a three-way valve 13. On startup and shutdown or in the event of faults, it was possible to run said stream G to a waste vessel 14, an open 60 litre metal vat with air extraction. In regular operation, stream G was guided to an extruder 18.

From the hexamethylene 1,6-diisocyanate reservoir 1, with the aid of a micro toothed ring pump 15 (MZR 6355 from HNP), a hexamethylene 1,6-diisocyanate stream J was withdrawn. The throughput of the hexamethylene 1,6-diisocyanate stream J was measured by means of a mass flow meter 16 (from Bronkhorst, Mini Cori-Flow M1X, maximum flow rate 2 kg/h). The temperature of the hexamethylene 1,6-diisocyanate stream J was likewise room temperature. This stream was likewise guided to the extruder 18.

The extruder 18 was a ZSK 26 MC from Coperion, which was operated at temperatures of 200° C. and a speed of 66 revolutions per minute. In this extruder, stream G, by means of a venting system 17 that was operated at a reduced pressure of about 1 mbar relative to ambient pressure, was freed of any inert gases entrained with streams of matter A and B and of possible volatile reaction products. Downstream of the addition of the oligomer stream G, the hexamethylene 1,6-diisocyanate stream J was added and the reaction to give the polymer was conducted. Before the end of the extruder, the resulting polymer stream was freed of volatile constituents via a degassing operation 19. The pressure in this degassing was 200 mbar below ambient pressure. The polymer stream K was expressed through two nozzles, cooled in a water bath 20 filled with deionized water (DI water), and chopped into pellets by means of a pelletizer 21.

Description of the Extruder Configurations Used:

Where “elements” are mentioned in the description that follows, these may be one or more elements. It will be clear to the person skilled in the art that extruder elements, given the same outline, fulfil the same function, irrespective of subdivision.

Extruder Configuration for Inventive Examples 1-3:

A metering point with devolatilization, followed by reverse-conveying elements having a length of 12 mm, a conveying zone of 48 mm having elements of slope 48 mm, in which the HDI has been metered in, followed by a kneading zone of 144 mm, a conveying zone of 32 mm with elements of slope 16 mm, a zone of length 24 mm with conveying elements of slope 24 mm, a kneading zone of 24 mm, a conveying zone of 248 mm having elements of slope 16 and 24 mm, a zone having reverse-conveying elements of length 12 mm, a zone having conveying elements having a length of 132 mm with devolatilization, and a zone of length 120 mm with conveying elements of slope 24 mm as pressure buildup zone upstream of the nozzle.

Extruder Configuration for Inventive Example 4:

A metering point with devolatilization, followed by reverse-conveying elements having a length of 12 mm, a conveying zone of 48 mm having elements of slope 48 mm, in which the HDI has been metered in, followed by a kneading zone of 144 mm, a conveying zone of 12 mm with an element of slope 12 mm, a zone of length 24 mm with conveying elements of slope 24 mm, a kneading zone of 24 mm, a zone having conveying elements having a slope of 12 mm of length 228 mm, a zone of length 24 mm with conveying elements of slope 24 mm, a zone having reverse-conveying elements of length 12 mm, a zone having conveying elements having a length of 132 mm and slopes of 48 mm and 24 mm with devolatilization, and a zone of length 120 mm with conveying elements of slope 24 mm as pressure buildup zone upstream of the nozzle.

Extruder Configuration for Inventive Example 5:

A metering point with devolatilization, followed by a reverse-conveying element having a length of 12 mm, a conveying zone of 48 mm having elements of slope 48 mm, in which the HDI has been metered in, followed by a kneading zone of 96 mm, a conveying zone of length 312 mm with a slope of 12 mm, a zone of length 72 mm with conveying elements of slope 24 mm, a zone having reverse-conveying elements having a length of 12 mm of slope 12 mm, a conveying zone having a length of 120 mm and elements having slope 48 mm with devolatilization, and a zone having conveying elements of slope 24 mm having a length of 144 mm as pressure buildup zone upstream of the nozzle.

TABLE 1
Streams of matter that were used for preparation of the
inventive examples.

| | Inventive | Inventive | Inventive | Inventive | Inventive |
|---|---|---|---|---|---|
| | example 1 | example 2 | example 3 | example 4 | example 5 |
| Stream A | 2.91 | 5.97 | 5.97 | 2.91 | 2.91 |
| [kg/h] | | | | | |
| Stream B | 2.00 | 4.00 | 4.00 | 2.00 | 2.00 |
| [kg/h] | | | | | |
| Stream J | 0.78 | 1.34 | 1.27 | 0.78 | 0.78 |
| [kg/h] | | | | | |

TABLE 2
Properties of the polymers described

| | Comparative | Comparative | Inventive | Inventive | Inventive | Inventive | Inventive |
|---|---|---|---|---|---|---|---|
| | example 1 | example 2 | example 1 | example 2 | example 3 | example 4 | example 5 |
| max. | 70.9 | 70.6 | 79.1 | 76.2 | 73.9 | 74.1 | 73.1 |
| flexural | | | | | | | |
| stress | | | | | | | |
| [MPa] | | | | | | | |
| M̅_{z} | 978 516 | 88 513 | 283 642 | 181 920 | 150 116 | 129 689 | 754 231 |
| [g/mol] | | | | | | | |
| M̅ₚₑₐₖ | 39 355 | 32 734 | 44 668 | 25 409 | 24 831 | 37 153 | 65 313 |
| [g/mol] | | | | | | | |
| M̅_{z}/M̅ₚₑₐₖ | 24.9 | 2.7 | 6.4 | 7.2 | 6.1 | 3.5 | 11.6 |
| Tg [° C.] | 27 | 28 | 30 | 27 | 25 | 26 | 27 |
| Tm [° C.] | 181 | 185 | 188 | 185 | 184 | 186 | 182 |

Table 2 shows that the two products reported in the prior art have either a very large M̅_{z}/M̅ₚₑₐₖ ratio (Comparative Example 1) or a small M̅_{z}/M̅ₚₑₐₖ ratio (Comparative Example 2). The flexural stresses determined on these examples are about 71 MPa.

By contrast, the inventive examples have a quotient of M̅_{z}/M̅ₚₑₐₖ within the range claimed of 3-15 and are notable for significantly higher flexural stresses of 73 MPa up to 79 MPa.

1. A thermoplastic polyurethane polymer obtained by the reaction of at least the following formation components:
A) one or more aliphatic diisocyanates having a molecular weight of 140 g/mol to 170 g/mol; and
B) one or more aliphatic diols having a molecular weight of 62 g/mol to 120 g/mol,
wherein the formation components used to produce the thermoplastic polyurethane polymer consist to an extent of at least 95% by weight of one or more aliphatic diisocyanates A) and one or more aliphatic diols B), based on a total mass of the formation components used, wherein the one or more aliphatic diisocyanates A) and the one or more aliphatic diols B) are used in a molar ratio in a range from 1.0:0.95 to 0.95:1.0, wherein the M̅_{z}/M̅ₚₑₐₖ ratio of the thermoplastic polyurethane is within a range from 3 to 15, wherein M̅_{z} is the centrifuge-average molar mass and M̅ₚₑₐₖ is the molar mass of the maximum of the gel permeation chromatography curve, each determined by gel permeation chromatography in hexafluoroisopropanol against polymethylmethacrylate as standard.

2. The thermoplastic polyurethane polymer according to claim 1, wherein the M̅_{z}/M̅ₚₑₐₖ ratio of the thermoplastic polyurethane is within a range from 3 to 14.

3. The thermoplastic polyurethane polymer according to claim 1, wherein the M̅_{z} of the thermoplastic polyurethane is within a range from 100 000 g/mol to 900 000 g/mol determined by gel permeation chromatography in hexafluoroisopropanol against polymethylmethacrylate as standard.

4. The thermoplastic polyurethane polymer according to claim 1, wherein the thermoplastic polyurethane polymer consists to an extent of at least 96% by weight of one or more aliphatic diisocyanates A) and one or more aliphatic diols B), based on a total mass of the polyurethane polymer.

5. The thermoplastic polyurethane polymer according to claim 1, wherein the one or more aliphatic diisocyanates A) are selected from the group consisting of 1,4-diisocyanatobutane, 1,5-diisocyanatopentane, 1,6-diisocyanatohexane, 2-methyl-1,5-diisocyanatopentane and/or mixtures of at least two of these.

6. The thermoplastic polyurethane polymer according to claim 1, wherein the one or more aliphatic diols B) are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least two of these.

7. The thermoplastic polyurethane polymer according to claim 1, characterized in that the thermoplastic polyurethane polymer has a urethane group content of 40% by weight to 60% by weight based on a total weight of the thermoplastic polyurethane polymer.

8. The thermoplastic polyurethane polymer according to claim 1, wherein the thermoplastic polyurethane polymer has a percent by weight ratio of O to N determined by means of elemental analysis of ≥1.5:1 to 2.6:1 and a percent by weight ratio of N to C determined by means of elemental analysis of ≥1:10 to 1:3.

9. The thermoplastic polyurethane polymer according to claim 1, wherein the thermoplastic polyurethane polymer is a semicrystalline thermoplastic polyurethane polymer.

10. The thermoplastic polyurethane polymer according to claim 1, wherein the thermoplastic polyurethane has a glass transition point of <50° C., determined by differential scanning calorimetry according to DIN EN 61006 (November 2004).

11. The thermoplastic polyurethane polymer according to claim 1, wherein the thermoplastic polyurethane polymer has a melting point of >150° C., determined by differential scanning calorimetry according to DIN EN 61006 (November 2004).

12. The thermoplastic polyurethane polymer according to claim 1, wherein there is at least 100° C. between the glass transition point determined by differential scanning calorimetry according to DIN EN 61006 (November 2004) and the melting point determined by differential scanning calorimetry according to DIN EN 61006 (November 2004) of the thermoplastic polyurethane.

13. The thermoplastic polyurethane polymer according to claim 1, wherein the formation components used to produce the thermoplastic polyurethane polymer consist to an extent of 95% by weight to 99.9% by weight of one or more aliphatic diisocyanates A) and one or more aliphatic diols B) and to an extent of 0.1% by weight to 5% by weight of one or more polyisocyanates C) and/or one or more NCO-reactive compounds D), based on the total mass of the formation components used.

14. A process for preparing a thermoplastic polyurethane polymer according to claim 1, wherein, in a first step, at least one or more than one aliphatic diisocyanate A) having a molecular weight of 140 g/mol to 170 g/mol is reacted with one or more aliphatic diols B) having a molecular weight of 62 g/mol to 120 g/mol to give at least one prepolymer, and wherein the at least one prepolymer obtained in the first step is reacted in a second step with at least one chain extender to give the thermoplastic polyurethane polymer.

15. A composition, comprising at least one thermoplastic polyurethane polymer according to claim 1 and at least one additive and/or a further thermoplastic polymer.

16. A thermoplastic moulding compound, comprising at least one composition according to claim 15.

17. A moulding, film and/or fibre, comprising at least one thermoplastic polyurethane polymer according to claim 1, at least one thermoplastic moulding compound according to claim 16, or at least one composition according to claim 15.

18. Use of a thermoplastic polyurethane polymer according to claim 1, a thermoplastic moulding compound according to claim 16 or a composition according to claim 15 for production of a moulding, film and/or fibre.

19. Use of a thermoplastic polyurethane polymer according to claim 1 for production of a composition or a thermoplastic moulding compound.
